(19) United States
(12) Patent Application Publication
(10) Pub. No.: US 2011/0094335 A1
(43) Pub. Date: Apr. 28, 2011

(54) INTERNAL PROPULSION AND ENERGY SOURCE

(76) Inventor: KENT KIDDER, Lubbock, TX (US)

(21) Appl. No.: 12/763,255

(22) Filed: Apr. 20, 2010

Related U.S. Application Data
(60) Provisional application No. 61/279,836, filed on Oct. 27, 2009.

(51) Int. Cl. F16H 21/44; F03B 17/04

(52) U.S. Cl. 74/99 A; 74/DIG. 9

(57) ABSTRACT

An internally self-propelled mechanism having a string anchored to a point on a propellable object or on an object requiring power to function and where the string has two or more segments that are pulled in two or more tangential directions from a centrally located brace creating angles so that the tension force effected on the middle string segment causes propulsion.

### CROSS REFERENCE TO RELATED APPLICATIONS

This application claims the benefit of provisional patent application 61/279,836 filed Oct. 27, 2009 by the present inventor and the application is hereto incorporated by reference in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE INVENTION

1. Field of the Invention

The disclosed invention relates to a novel method and device for propulsion using unbalanced internal forces to cause internal acceleration and linear motion in a mechanism, as an inseparable unit in a specified direction of travel, and more particularly to a method and device that will cause linear propulsion without the use of external force or externally applied energy.

2. Description of Related Art

The use of external force or external energy to power propulsion is well known in the prior art. Vehicles, planes, boats and machines are powered by a fuel source, electricity or other externally created power means. The cost of externally created power is staggering, resulting in not only economic expense but also depletion of natural resources, dependency on foreign resources and environmental damages.

The quest for a form of internal energy has never died but is felt by most to be an impossibility. We are all taught from a young age that objects are inert without the application of an external force or energy source. Motion without some sort of external force or power is not recognized as a possibility. Newton's law specifies that “for every action there is an equal and opposite reaction” which has further limited the possibilities of internally created propulsion. Rocket propulsion utilizes this law effectively but as a consequence requires a staggering amount of fuel to achieve liftoff.

In recent years various inventors have developed methods of internally created propulsion using the Coriolis force and/or centrifugal force. Robert Cook was awarded U.S. Pat. Nos. 3,683,707 and 4,238,968 entitled “Device for converting Centrifugal Force to Linear Force and Motion.” Cook's theory was based on using unbalanced rotators to create a centrifugal force that ultimately resulted in linear motion, achieving, seemingly for the first time, linear propulsion without the use of external force. His prototype, however, required a motor and four rotors.

In 2001, U.S. Pat. No. 6,321,783 was granted to Kangas, et al describing a closed system motor that achieved propulsion by causing fluid to circulate in opposite directions to cause an internal state of unbalanced forces resulting in an energy source. His patent disclosed the requirement of a closed system of circulating fluid which potentially required a pump to circulate the fluid and thus limited the potential applications for the invention.

Also well known in the art are the use of pulleys and cams in order to utilize leverage to decrease the amount of force needed to propel or lift an object. Pulley and cams use angle tension to achieve their purpose. They still however require an external force to exert a minimum amount of force to initiate movement.

A simpler and more efficient method and device is needed to achieve propulsion and or power by internally creating force, without the use of centrifugal force or external energy.

### NOTATION AND NOMENCLATURE

Certain terms are used throughout the following description to refer to particular method components. As one skilled in the art will appreciate, design and manufacturing companies may refer to a component by different names. This document does not intend to distinguish between components that differ in name but not function.

In the following discussion, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more components” combined together. Thus, a method can comprise an “entire method” or “sub methods” within the method.

### SUMMARY OF THE INVENTION

The disadvantages shown in the prior art are solved by a method and apparatus for using internal energy obtained by internally producing unbalanced forces, without using centrifugal force, within an object's parts to achieve propulsion.

It is an objective of the disclosed invention to achieve motion without the use of external force or energy.

It is further an objective of the disclosed invention to attach the apparatus to the spokes of a wheel to turn the wheel, providing internal power to the axle of the wheel to operate a Power-Take-Off.

It is further an objective of the disclosed invention to power electric generators and a variety of moving mechanisms.

It is further an objective of the disclosed invention to power vehicles.

It is further an objective of the disclosed invention to lift and accelerate a vehicle no matter whether it is in air, outer space, in water or underground.

It is further an objective of the disclosed invention to provide a means to steer a vehicle whether by turning the apparatus within the vehicle or by turning the vehicle relative to an outside point. The turning of the vehicle and/or the mechanism may be accomplished by using smaller propulsion mechanism.

It is further an objective of the disclosed invention to operate an engine without fuel.

### BRIEF DESCRIPTION OF THE DRAWINGS

The drawings contained herein represent preferred embodiments of the invention and are not intended to limit the scope. For a detailed description of various embodiments, reference will now be made to the accompanying illustrative drawings in which:

FIG. 1 illustrates a side view of a preferred embodiment of the disclosed method and apparatus.

FIG. 2 illustrates a preferred embodiment of the disclosed method and apparatus.

FIG. 3 illustrates a preferred embodiment of the disclosed method and apparatus.

FIG. 4 illustrates an embodiment of the disclosed method and apparatus.

FIG. 5 illustrates an embodiment of the disclosed method and apparatus.

FIG. 6 illustrates an embodiment of the disclosed method and apparatus.

FIG. 7 illustrates an embodiment of the disclosed method and apparatus.

FIG. 8 illustrates an embodiment of the disclosed method and apparatus.

### DETAILED DESCRIPTION OF THE PREFERRED EMBODIMENTS

The conservation of momentum theory teaches that the linear momentum of a particle is the product of its mass and velocity, or p=mv. Newton's second law of motion embodies momentum and can be stated as “the resultant of the forces acting on a particle is equal to the rate of change of the linear momentum of the particle.” When the resultant external force acting on a system of particles is zero, it is thought that the linear momentum of the system remains constant.

The disclosed invention is a method and device capable of propulsion using only internal forces. The disclosed invention is a complete mechanism with a force being exerted between the parts of a mechanism so as to exert a tension on a string while the string is positioned in a loop around a brace and extending as two separate string segments in two tangential directions from the brace so as to pull on the two separate tethers that are attached to the frame in tangential direction from each other's pull. The entire string has the same tension. These forces in the two tangential directions cause force against the frame which are not in the opposite direction. The forces against the tether are equal but not in opposite directions. The results of the forces application causes the frame and entire mechanism to move.

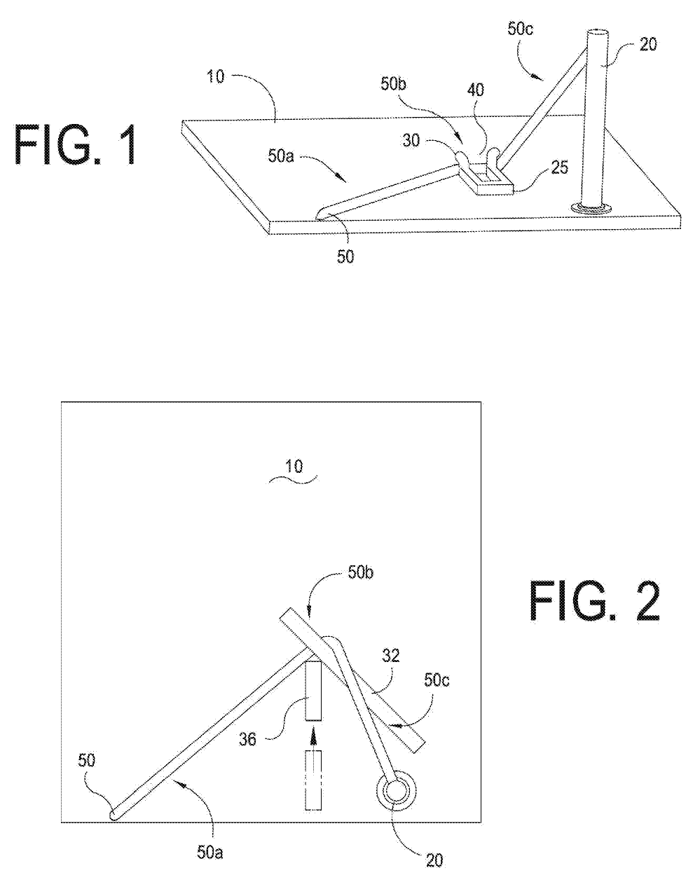

Turning to the illustrations, FIG. 1 depicts a perspective view of a preferred embodiment of the disclosed invention, showing a flat platform 10 with a pole 20 attached perpendicularly to Platform 10 with string 50 consisting of string segments 50a, 50b and 50c tethered to the pole 20, at its uppermost end and extending at the angle approximately 67° downward, as shown in the drawing, and sideward and rearward to the flat surface of the platform, with the platform 10 making up the main frame of the mechanism. The string 50 hooks around a brace and under the first raised portion 40 of the brace 25. Force against the brace 25 holds it downward to rest just above the platform 10 and to force the brace 25 sideward against the string 50.

The string segment 50b will extend backward under the second raised portion 30 of the brace 25, and at this portion of the brace 25, the string 50 is pulled sideward to become string segment 50a where the string segment 50a extends backward and sideward to the point it is anchored to platform 10.

Only downward and sideward force is exerted against the brace 25 at the corners 30 and 40 of the brace. The forward force that is exerted against the string 50 at the brace corner 40 and the rearward force exerted on the string at corner 30 of the brace 25 will equal each other. However, the force exerted forward on the platform 10 by string segment 50a at the point where it tethers to the platform 10 is greater than the rearward force exerted by string segment 50c against the post 20 at the tether of string segment 50c. Therefore, the platform 10 will receive a net forward acceleration. No net balancing force will be exerted in the opposite direction against platform 10. The result is that platform 10 will be moved by the unbalanced force within the mechanism. It is assumed that the portions where the brace 25 makes contact with the string 50, that the contact is frictionless.

FIG. 2 is uniquely different from FIG. 1, because it is equipped with a separated lateral brace 32 which is mounted so as to lie across string 50 and sideward against the descending portion of string 50 so that as the brace 32 is forced downward and sideward it is pushed into the bend in string 50 so that when the movable brace 36 is forced sideward across the platform 10, the brace 36 will force string 50 sideward and backward, and will force the lateral brace 32 sideward and forward against the string 50. The angles against brace 36 is 45° rearward and 45° forward and thus are in balance. The tension on the string 50 remains constant throughout the entire length of string 50 and due to the greater angle forward than rearward where string 50 is tethered at the front pole 20 of platform 10 the greater unequal forward force will cause the acceleration of the platform 10 in a forward direction.

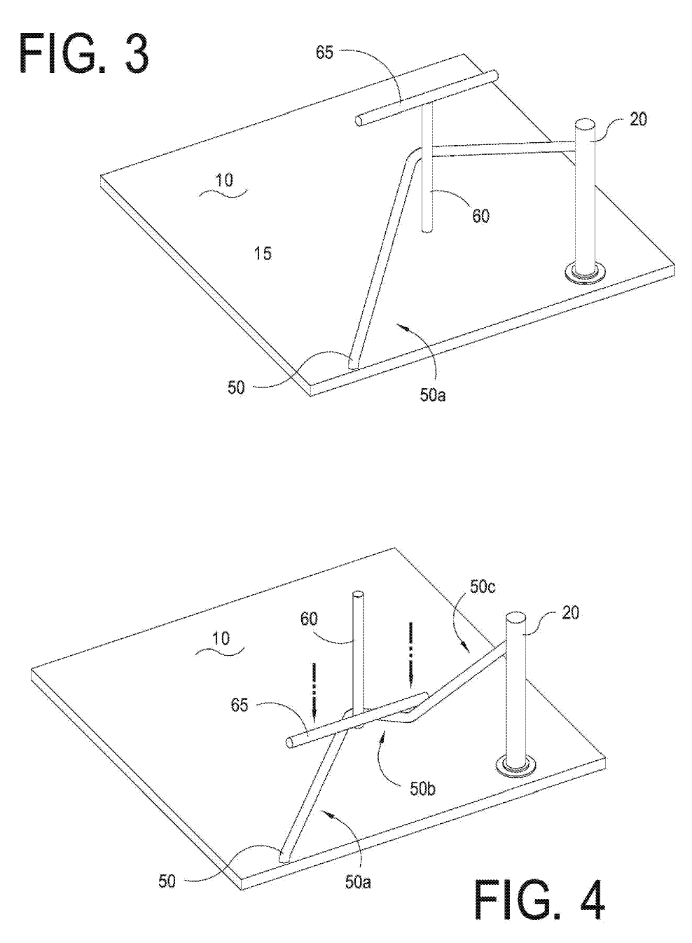

FIGS. 3-4, show the same platform as it appears in separate stages of action steps.

In FIG. 3, string segment 50a is attached at the rear of the platform and extends sideward and forward around brace 60, after which string segment 50c exits from under the front edge of brace 60. It extends forward, sideward and upward to its tether at the top of pole 20.

In FIG. 4, stage 2 of the action, there is no tension on the string. The forward to rearward, moveable brace, 65 is forced downward against the string 50 and sideward against brace 60 to force the string sideward and downward. This causes the string segment 50c to be forced downward and sideward at a slope from its tether on pole 20 to the brace 65 just above the platform. String segment 50a extends only sideward and forward from its tether on the platform 10 and forces only sideward and forward on the platform 10, while string segment 50c not only forces sideward and rearward, but also downward. Now, with the same tension on 50a and 50c, a greater force is exerted forward and sideward on 50a than is exerted sideward and rearward on line segment 50c. The rearward and sideward force against the tether on pole 20 is made up for by the downward force against the tether on the pole 20. This extra force exerted by string 50a to pull the platform 10 forward is unbalanced and causes the platform 10 to accelerate. The contacts where the string 50 touches braces 60 and 65 are frictionless so that the only forward or rearward force exerted against the platform is exerted by the tension on the string.

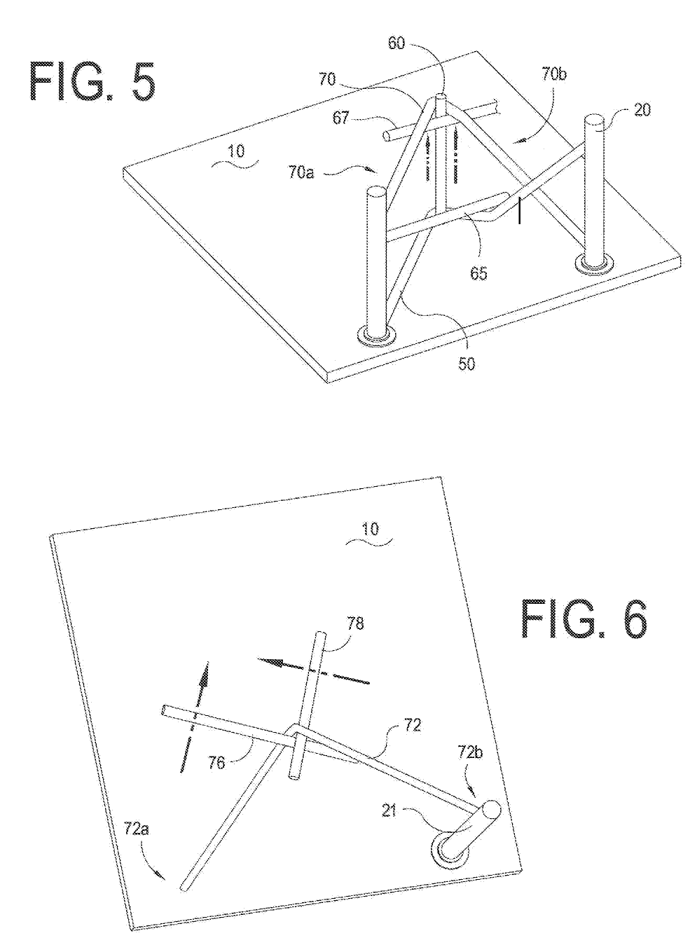

FIG. 5 is a duplication of FIGS. 3-4, with one addition. The addition is a second string and brace system. In FIG. 5 the cross brace 65 is forced sideward across the platform 10 and consequently exerts a force to push the string 50 sideward and downward, while, at the same time the upper cross brace 67 is forced sideward and upward to push string 70 sideward and upward. Brace 60 transfers force from brace 65 to string 50 and force from brace 65 to string 70. In the resulting angle of the string segment 50, the string segment is taunt at a forward angle that is greater than the rearward angle of string segment 50B and the resulting angle of string segment 70A is taunt at a forward angle that is greater than the rearward angle of string segment 70B so that greater forward force is exerted against the platform. In each string the tension is the same from one end to the other.

FIG. 6 shows a platform 10, with a string 72, and tethers 72a and 72b that are attached in the same manner as the string in FIG. 1, with only one difference. That difference is that the loop in string 72 is forced downward and sideward by two separate movable braces. Brace 76 forces downward, sideward and forward on string 72 and brace 78 forces backward and sideward on string 72. The force direction arrows (1) and (2) indicate the direction that the force is exerted across the platform. Segment 72 is tensioned between the tether 72a and extends to the brace 76 where, after it extends underneath of brace 76, it makes a 90° angle to extend upward past brace 78. The front part of the string 72 is tethered to the top of the pole 21 and extends downward to become string segment 76. At the same time string segment 76 comes up from under brace 76 to become segment 72b. All contacts in the apparatus are frictionless.

In this simple apparatus the many angles and magnitude of forces can be accommodated and adapted to demonstrate this to be the point of the paradigm.

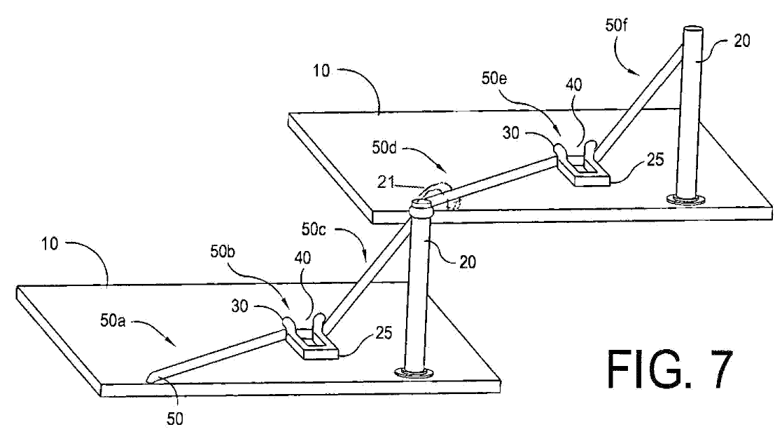

FIG. 7 is an exact duplicate of FIG. 1, except it depicts two units operating in line with each one common string, and in operating in line they provide the addition of one more equal force than was shown in FIG. 1. Hooked brace 21 is mounted to post 20 so that the string 50 slides freely past post 20 and the hooked brace 21. This causes the tension on segments 50c and 50d to be the same. In this unit increasing the tension on the string causes an increase in acceleration on both portions of the unit. So in this combination of two equal units the same tension doubles the acceleration.

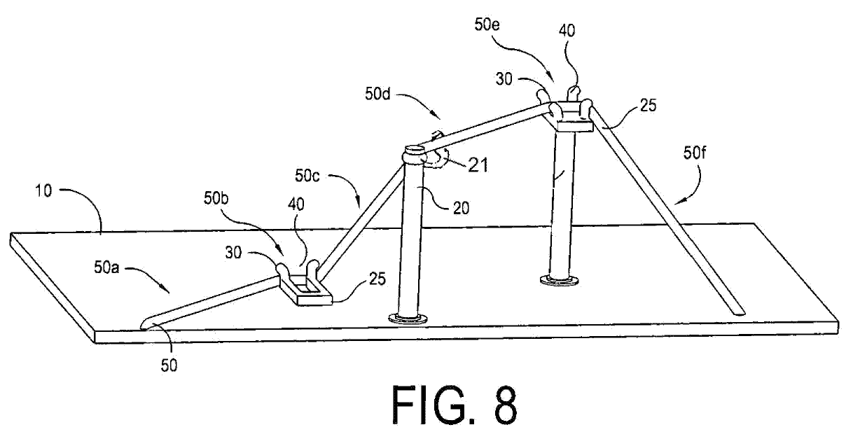

FIG. 8 also operates as FIG. 7 to double the acceleration of the unit. Both FIGS. 7-8 use the same frame as FIG. 1. In FIG. 8 the hooked brace 21 allows the string 50 to freely skip past the post 20 and, as in FIG. 7, the acceleration is doubled.

Therefore, the platform 10 will receive a net forward acceleration. No net balancing force will be exerted in the opposite direction against the flat platform 10. The result is that the flat platform 10 will be moved by the unbalanced force within the mechanism.

The method and device disclosed herein achieve significant advantages over the prior art in that linear motion in the disclosed invention is achieved by using only internal forces. Those internal forces are created by creating an imbalance of tension internally by creating string segments pulled tangentially at angles. There is no need to have a motor or liquids to create centrifugal force as in the prior art.

This remarkable breakthrough uses the simplest of all technologies, tension force achieved by strings pulled at angles to propel an object without the use of external force. The applications for such simple, inexpensive yet powerful technology are limitless. The technology could be used to power vehicles on the ground, vehicles or planes traveling through the air, boats, submarines and literally any other mechanism where linear propulsion or even motor operation is desired. Because of the simplicity of the technology, it could be used on a nano scale in the smallest of mechanisms.

Many of the units can be used on one object to achieve greater effect, whether the desired result is acceleration or power. Furthermore, a large number of separated units could be placed on or to work in conjunction with one object, each operating independently from the other, either by pre-programmed instructions, manual operation, or radio operation, to work together to accomplish a task.

While the disclosed method and apparatus has been described in conjunction with the preferred embodiments thereof, many changes, modifications, alterations and variations will be apparent to those skilled in the art. The invention should therefore not be limited to the particular preferred embodiment disclosed but should include all embodiments that could fall within the scope of the claims.

Accordingly, the preferred embodiments of the invention shown in the drawings and described in detail above are intended to be illustrative, not limiting, and various changes may be made without departing from the spirit and scope of the invention as defined by the claims set forth below.

What is claimed is:

1. An internally self-propelled mechanism comprising:
a propellable object;
a string having a first end and a second end where the first end is anchored to a point on the propellable object and having two or more segments that are pulled in two or more tangential directions from a centrally located brace wherein the first string segment is tethered to a fixed perpendicular post and travels downward and sideward creating a first downward angle greater than 45° and wherein sideward tension is placed on the midpoint area of the string by the centrally located brace causing the second string segment to form a second angle of greater than 45° as it continues to travel laterally and tangentially from the first segment to an anchoring point at which point the string terminates and wherein as tension force is applied to the midpoint area of the string linear propulsion of the propellable object occurs.

2. The internally self-propelled mechanism of claim 1 wherein the propellable object may be a surface atop one or more wheels.

3. The internally self-propelled mechanism of claim 1 wherein the propellable object may be a vehicle.

4. The internally self-propelled mechanism of claim 1 wherein the propellable object may be an airplane.

5. The internally self-propelled mechanism of claim 1 wherein the propellable object may be a ship.

6. The internally self-propelled mechanism of claim 1 wherein the propellable object may be a submarine.

7. The internally self-propelled mechanism of claim 1 wherein one or more units are attached to the hull of a spacecraft for the purpose of flight as well as landing or lifting the ship off from large gravitational masses such as planets.

8. The internally self-propelled mechanism of claim 1 wherein more than one unit is attached to a propellable object to achieve greater acceleration.

9. The internally self-propelled mechanism of claim 1 wherein the first angle is selected from the range of 45° to 85°.

10. The internally self-propelled mechanism of claim 1 wherein the first angle is selected from the range of 45° to 85°.

11. An internal propulsion mechanism comprising: an object requiring power to function; a string anchored to a point on the object and having two or more segments that are pulled in two or more tangential directions from a centrally located brace wherein the first string segment is tethered to a fixed perpendicular post and travels downward and sideward at an angle greater than 45° and wherein sideward tension is placed on the midpoint area of the string which comprises a second string segment by the centrally located brace causing the second string segment to form an angle of greater than 45° and wherein the string continues to travel laterally and tangentially from the first segment to an anchoring point at which point the string terminates and wherein the tension force applied to the second string segment by the centrally located brace causes linear propulsion of the object.

12. The internal propulsion mechanism of claim 11 wherein the object requiring power to function is a motor.

13. The internal propulsion mechanism of claim 11 wherein the object requiring power to function is a generator.

14. The internal propulsion mechanism of claim 11 wherein the object requiring power to function is a battery.

15. The internal propulsion mechanism of claim 11 wherein more than one unit may be attached to the object to gain greater power.

16. A method of powering an object using only internal parts comprising the steps of:
extending a string having a first end and a second end;
tethering the first end of the string at a height on a perpendicular post anchored to an object so that the string travels downward and laterally from the perpendicular post creating a first downward angle of greater than 45° angle;
passing the midpoint of the string partially around a moveable brace that is anchored to the object and that has one or more parts such that the brace exerts sideward frictionless tension on the slack in the string;
anchoring the second end of the string to a point on the object that is located tangentially from the moveable brace such that as the string leaves the brace it creates a second angle of greater than 45°.

17. The method of claim 16 wherein the first downward angle is selected from a range of 45° to 85°.

18. The method of claim 16 wherein the second angle is selected from a range of 45° to 85°.
